(19) United States
(12) Patent Application Publication
(10) Pub. No.: US 2004/0079249 A1
(43) Pub. Date: Apr. 29, 2004

(54) Printing mechanism with tempering device

(75) Inventors: Reinhard Stuber, Reinbek (DE); Mathias Blau, Hamburg (DE)

Correspondence Address: GREENBLUM & BERNSTEIN, P.L.C., 1950 ROLAND CLARKE PLACE, RESTON, VA, 20191, US

(73) Assignee: Hauni Maschinenbau AG, Hamburg (DE)

(21) Appl. No.: 10/678,151

(22) Filed: Oct. 6, 2003

(30) Foreign Application Priority Data
Oct. 28, 2002 (EP) 02 024 033.9
Mar. 31, 2003 (EP) 03 007 225.0

(51) Int. Cl. B41F 31/02

(52) U.S. Cl. 101/364; 101/35

(57) ABSTRACT

Printing mechanism, printing process and machine of the tobacco processing industry. The printing mechanism includes a tempering device to adjust a temperature of the ink. The machine can be, e.g., a cigarette rod machine. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of European Patent Application No. 02 024 033.9, filed on Oct. 28, 2002 and European Patent Application No. 03 007 225.0, filed on Mar. 31, 2003, the disclosures of which are expressly incorporated by reference herein in their entireties.

### BACKGROUND OF THE INVENTION

1. Field of the Invention

The invention relates to a printing mechanism of a machine of the tobacco processing industry, in particular a cigarette rod machine. The invention further relates to the use of a tempering device and a machine of the tobacco processing industry, in particular a cigarette rod machine.

2. Discussion of Background Information

In the tobacco processing industry, rod machines are used to produce continuous, wrapped rods. A wrapped rod chiefly means in particular an endless filter rod or a tobacco rod made from tobacco, which rod is provided with a wrapping strip of paper, foil or the like.

A marking, lettering or a brand logo or the like is printed on the wrapping strip of the tobacco rod or cigarette rod by a printing mechanism located in the rod machine. The ink intensity of the marking is optically checked by the operators, and corrections to the ink intensity are made manually. As a rule, manual intervention does not occur until the intensity of the impression exceeds a pre-set limit. In particular, numerous corrections have to be made during start-up of the rod machine, e.g., after a longer down-time, since the quality of the print depends on the viscosity of the printing ink, which is in particular temperature-sensitive.

The temperature of the printing mechanism changes in the course of the operation of a rod machine, so that this leads to changes in the viscosity of the printing ink and to an uneven print intensity.

German Patent Application No. DE-A-29 16 212 discloses an inking device for a printing press, in which cooling water flows through the inking rollers. Furthermore, a process for printing webs is known from German Patent Application No. DE-A-3 1 01 243. In this connection, the printing ink is heated by heated printing rollers in sections of the feed path in order to adjust the viscosity of the ink to the respective work section.

### SUMMARY OF THE INVENTION

On the basis of this prior art, the instant invention improves the printing quality of a printing mechanism of a machine of the tobacco processing industry, in particular a cigarette rod machine. In particular, high printing quality should be quickly achieved after start-up of the machine and should be kept constant for the continuous operation of the machine.

Accordingly, the printing mechanism of the type mentioned at the outset is provided with a tempering device.

In general, it is advisable for the printing mechanism to maintain a constant temperature level of the printing ink, since the printing ink is sensitive to temperature fluctuations. With cold printing mechanisms, the printing ink is close to the ambient temperature. Through the tempering of the ink system or of the printing mechanism according to the invention, the optimum operating temperature can be reached for the printing ink within a short time after start-up at any time, i.e., even after a long down-time. A high printing quality is quickly achieved through the targeted heating of the printing mechanism or the printing ink after a cold start of the machine, since the ink-guiding parts of the printing mechanism are (pre-)heated. The temperature of the printing ink and, thus, the viscosity are quickly reached during continuous operation. Furthermore, the viscosity of the printing ink can be kept constant by the tempering device. In the printing mechanisms, heat is generated during the printing operation by the churning of the rubberized ink transfer rollers and through the development of heat by gears or drives. If the development of heat exceeds the operating temperature of the printing mechanisms, an uneven ink transfer occurs. As a result, the printing quality is negatively affected. Through the tempering device according to the invention, the temperature is kept at a constant level during continuous operation, whereby the printing mechanism is cooled in the event of an excessive development of heat.

The tempering device preferably features at least one heating element and/or at least one cooling element.

Furthermore, the ink supply and/or the metering device and/or the ink nozzle of the printing mechanism are provided with a heating element.

In particular, the heating element includes a heating cartridge. Furthermore, a temperature sensor can be positioned near the ink supply and/or the metering device and/or the ink nozzle or can be positioned on or in the ink supply and/or the metering device and/or the ink nozzle. The temperature of the printing ink or of an ink guiding part of the printing mechanism can be exactly determined by the temperature sensor. Thus, the optimum operating temperature for the printing ink can be adjusted on the: basis of the determined temperature and kept at a constant level.

In a further development of the invention, the cooling element is embodied or formed as a cooling plate.

An efficient cooling of the printing mechanism or the ink guiding parts of the printing mechanism is achieved when a medium, in particular, a cooling medium, can flow through the cooling element. In this manner, heat is efficiently dissipated.

Furthermore, the printing mechanism is arranged at least partially on the cooling plate.

If the cooling element includes a device producing a cooled air flow, a cost-effective temperature control is possible that ensures a desired printing quality. Furthermore, a low soiling of the inking device can be achieved.

In a preferred embodiment of the invention, a control unit or regulating unit is provided for the tempering device, so that the printing ink or the printing mechanism or its ink guiding parts feature a constant operating temperature during operation.

Further, printing quality is improved through the use of a tempering device for a printing mechanism of a machine of the tobacco processing industry, in particular, a cigarette rod machine. The advantageous embodiments of the tempering devices result are shown in the above description, to which reference is expressly made.

Furthermore, the invention is directed to a machine of the tobacco processing industry, in particular, a cigarette rod machine including the above-described printing mechanism.

The present invention is directed to a printing mechanism of a machine of the tobacco processing industry that includes a tempering device.

In accordance with the instant invention, the machine can be a cigarette rod machine.

According to a feature of the invention, the tempering device can include at least one of at least one heating device and or at least one cooling device. The printing mechanism can also include an ink supply, a metering device, and an ink nozzle. The heating element may be located with at least one of the ink supply, metering device, and ink nozzle. The heating element may include at least one of a heating cartridge and a heat sensor. Moreover, a temperature sensor can be positioned one of (a) near at least one of the ink supply, metering device, and ink nozzle or (b) on or in at least one of the ink supply, metering device, and ink nozzle. The cooling element can include a cooling plate. The cooling element may be structured and arranged for a medium to flow through the cooling element. Still further, the ink supply, metering device, and ink nozzle can at least partially be located on the cooling plate. The cooling element may include a device structured to produce a cooled air flow. Further, the cooling element can include an eddy current generator.

According to another feature of the invention, the tempering device can include a control or regulating unit.

Moreover, the printing mechanism can include an ink nozzle. A heating cartridge can be located one of integrally in the ink nozzle or to lie against the ink nozzle. Further, a temperature sensor may be located one of in and one the ink nozzle. Further still, a plurality of distributor rollers, a stamp roller, and a pressure roller can be provided. Two of the plurality of distributor rollers may be arranged to receive ink from the ink nozzle, and the stamp roller and the pressure roller can be arranged to guide a paper strip to be printed. A device can be provided to measure ink pressure before discharge from the ink nozzle.

The present invention is directed to a process for printing with a printing mechanism that includes a tempering device. The process includes adjusting a temperature of ink in the printing mechanism via the tempering device.

According to the invention, the printing mechanism may be located within a machine of the tobacco processing industry. Further, the machine can be a cigarette rod machine.

In accordance with a feature of the invention, the tempering device can include at least one of at least one heating element and at least one cooling element. The ink temperature can be adjusted by the at least one of the at least one heating device and the at least one cooling device. The ink temperature can be adjusted in at least one of an ink supply, a metering device, and an ink nozzle of the printing mechanism by the at least one heating element. Further, the at least one heating element can include a heating cartridge. The at least one cooling element can include a cooling plate, and the ink temperature can be adjusted by the cooling plate. The process can also include flowing a medium through the cooling element. At least some components of the printing mechanism may be located at least partially on the cooling plate, whereby the components are cooled by the cooling plate. The at least one cooling element can include a device producing a cooled air flow, and the ink temperature may be adjusted by directing the cooled air flow toward a portion of the printing mechanism.

The process can further include controlling or regulating the tempering device through a control or regulation device.

According to another feature of the instant invention, the process can also include heating the ink in the ink nozzle.

In accordance with still another feature of the invention, the process includes detecting a temperature of the ink in the ink nozzle.

Still further, the process may include measuring ink pressure before discharge from the ink nozzle.

The present invention is directed to a machine of the tobacco processing industry that includes the above-noted printing mechanism. Further, the machine can be a cigarette rod machine.

In accordance with still yet another feature of the present invention, the invention is directed to a process for printing a cigarette paper strip in the above-described machine, in which the process includes guiding the cigarette paper strip to a printing mechanism having a tempering device, and adjusting at least one of a temperature and a viscosity of the ink in the printing mechanism via the tempering device.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically illustrates a perspective view of a PROTOS-type cigarette rod machine in which the instant invention can be arranged;

FIG. 2 diagrammatically illustrates a printing mechanism in accordance with the feature of the invention; and

FIG. 3 diagrammatically illustrates another printing mechanism according to the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

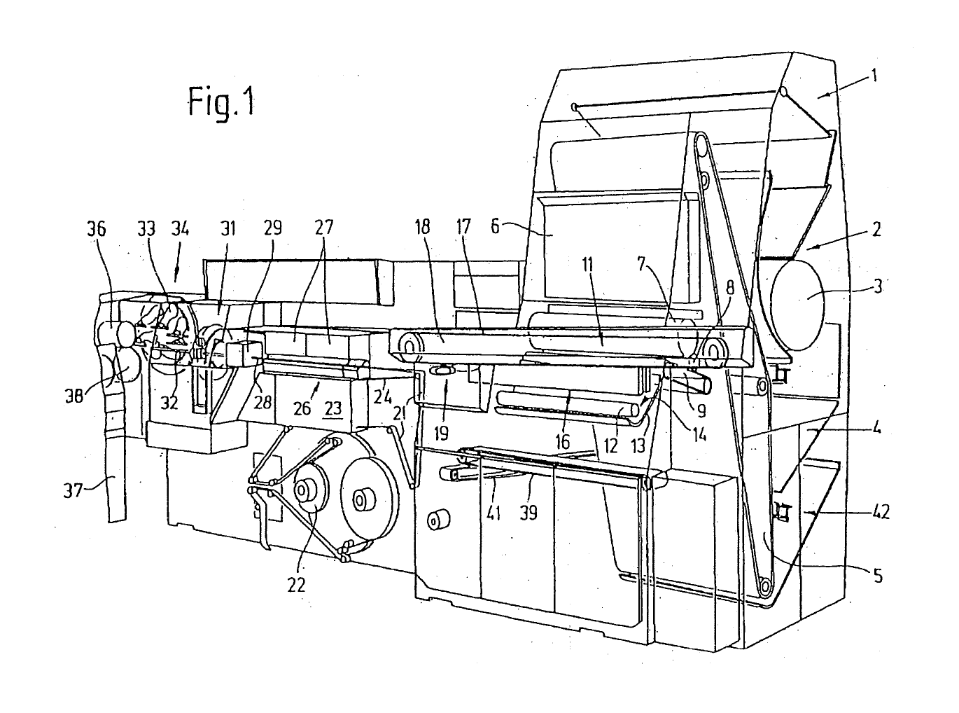

FIG. 1 shows a PROTOS-type cigarette rod machine of the applicant in a diagrammatic perspective view. A pre-distributor 2 is loaded with tobacco in portions from a sluice 1. A removal roll 3 of pre-distributor 2 adds tobacco in a controlled manner to a storage containers 4 from which a belt conveyor 5 removes tobacco and loads an upright duct 6 in a controlled manner. A pin roll 7 removes a uniform tobacco flow from upright duct 6, which tobacco flow is shaken out of the pins of pin roll 7 by a shake out roll 8 and centrifuged onto a rotating dispersion cloth 9.

A tobacco web formed on dispersion cloth 9 is centrifuged into a sifting device 11 that essentially comprises an air curtain through which larger or heavier tobacco parts pass, while all other tobacco particles are guided by the air into a funnel 14 formed by a pin roll 12 and a wall 13. The tobacco is centrifuged by pin roll 12 into a tobacco channel 16 against a rod conveyor 17, on which the tobacco is held by means of air suctioned into a vacuum chamber 18, and a tobacco rod is dropped. A leveler 0.19 removes excess tobacco from the tobacco rod, which is then laid on a cigarette paper strip 21 guided in the same direction.

Cigarette paper strip 21 is drawn from a bobbin 22, guided through a printing mechanism 23 and laid on a driven garniture belt 24.

Garniture belt 24 transports the tobacco rod and cigarette paper strip 21 through a garniture 26 in which cigarette paper strip 21 is folded around the tobacco rod so that one edge still projects, which edge is glued in the known manner by a gluing device (not shown). Then the glued seam is closed and dried by a tandem seam sealer 27. A cigarette rod 28 thus formed passes through a rod density gauge 29 that controls leveler 19 and is cut into double-length cigarettes 32 by a knife device 31.

Double-length cigarettes 32 are transferred to a takeover drum 36 of a filter tipping machine 37 by a transfer device 34 featuring controlled arms 33, on the cutting drum 38 of which filter tipping machine they are divided into individual cigarettes by a circular knife.

Conveyor belts 39 and 41 convey excess tobacco into a container 42 arranged under storage container 4, from which container the returned tobacco is removed again by belt conveyor 5.

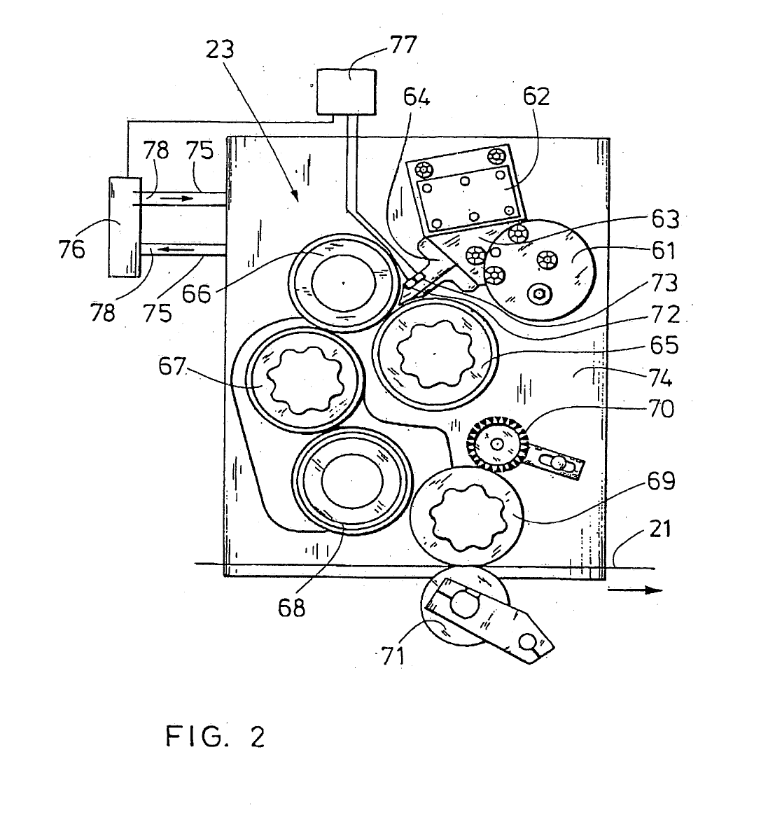

FIG. 2 shows in more detail printing mechanism 23. In printing mechanism 23, the printing ink is prepared for loading the stamp body. In a high-pressure process, cigarette paper strip 21 is provided with a corresponding imprint. To this end, the ink is pressed out of a cartridge 61 to ink pump 62 with the aid of compressed air. Pump 62 conveys the ink through a connection block 63 into an ink nozzle 64. Ink nozzle 64 has a narrow discharge aperture and, applies ink between a distributor roller 66 and a distributor cylinder 65.

The amount of ink emerging from ink nozzle 64 is determined in particular by the viscosity of the ink before the discharge aperture of ink nozzle 64 and by the pressure exerted by ink pump 62. According to the invention, the ink is heated in ink guiding parts 61, 62, 63 and 64, so that, during start-up of a cold cigarette rod machine, the operating temperature of the printing ink or the operating viscosity is quickly reached. The entire ink system is already in balance after only a few minutes. Moreover, through the pre-heating according to the invention, t ink pump 62 has to build up a lower pressure. Preheating the printing ink can be realized in particular through the installation of a heating cartridge 72 in ink nozzle 64. Heating cartridge 72 comprises, e.g., at least one resistor that can be heated electrically and is covered in particular with a highly conductive casing. The heating cartridge is, e.g., integrated into ink nozzle 64 or lies against it. Furthermore, a temperature sensor 73 is arranged on or in ink nozzle 64, in order to measure the temperature of ink nozzle 64.

In a further embodiment, the pressure of the printing ink is regulated. To this end, the ink pressure is measured shortly before the discharge aperture of ink nozzle 64. During production, a machine control regulates the pump rotational speed to a constant ink pressure before the discharge aperture. Together with the constant temperature of the ink or viscosity, this results in an exact amount of ink discharged, so that even print intensities are achieved on cigarette paper strip 21.

The amount of ink applied between a distributor roller 66 of rubber and a distributor cylinder 65 of steel is transferred by the distributor roller 66 to a distributor cylinder 67 that conveys the ink to a distributor roller 68. The distributor roller 68 touches a stamp roller 69, by which printed images are printed on cigarette paper strip 21. During the printing of conveyed cigarette paper strip 21, cigarette paper strip 21 is pressed against stamp roller 69 by a pressure roller 71. Stamp roller 69 prints cigarette paper strip 21 with a company logo or a brand name of a cigarette or the like. A brush 70 is provided on stamp roller 69 to clean the stamp roller 69, in order to remove excess printing ink from stamp roller 69.

In order to achieve a constant temperature of the printing inks in continuous operation of the cigarette rod machine, a cooling device of printing mechanism 23 is provided as well as the heating device. A cooling of printing mechanism 23 is necessary if there is an excessive heat development in printing mechanism 23. As a result of the increased heat, an uneven ink coating occurs and thus an impairment of the print quality. To cool printing mechanism 23, a cooling plate 74 is provided to which the mechanical components of the printing mechanism 23 or rollers and cylinders are attached. Moreover, cooling plate 74 features channels into which a cooling fluid 78, e.g., water, is fed and flows through. Cooled plate 74 dissipates the heat flow in printing mechanism 23 via flowing cooling fluid 78. In order to guide cooling fluid 78 through the channels, a pump (not shown) is preferably provided which conveys cooling fluid 78 through the channels and lines 75 and in particular also through a cooling device 76, e.g., a heat exchanger.

A control or regulation by a temperature adjusting device 77 or a temperature control unit 77 preferably takes place to control heating element 72 or cooling device 76 as a function of the measured temperature at ink nozzle 64. Temperature adjusting device 77 can also control the pumping power or the heating of the ink in ink container 61, ink pump 62, connection block 63 and/or ink nozzle 64.

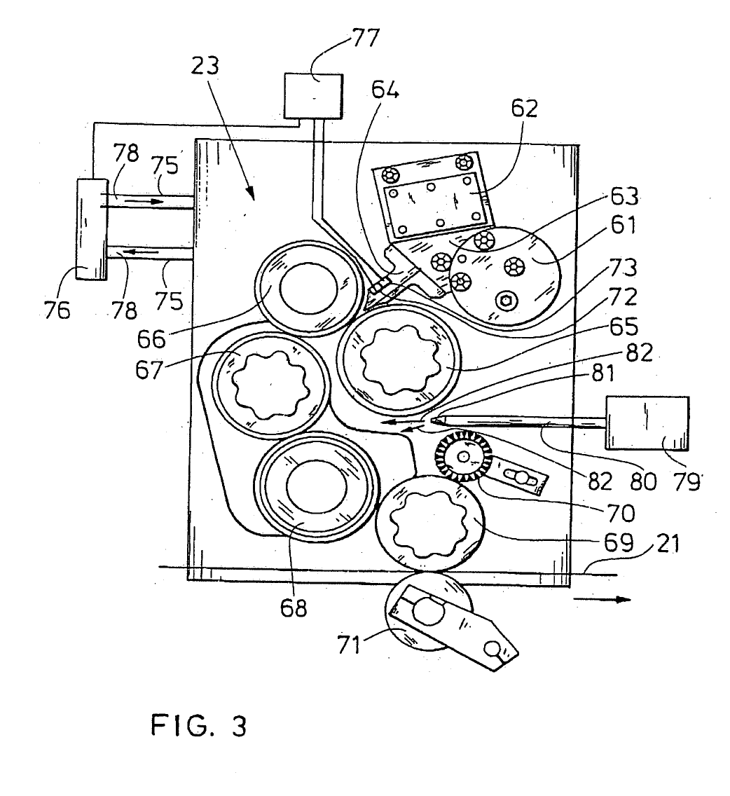

FIG. 3 shows a diagrammatic view of a printing mechanism according to the invention in a second embodiment. In this embodiment, instead of a cooling plate 74 (which is shown in FIG. 2) a cold air device comprising a cold air generator 79, a line 80 and a nozzle 81 can be provided. Cold air generator 79 can be, e.g., a cold air pistol, e.g., a so-called AIRTX eddy current generator. Such a cold air device or such an eddy current generator is also known under the name “Vortex Rohr” (“vortex pipe”) and can be ordered from KNIGHT EUROPE GMBH & Co. KG, 40789 Mohnheim. The manufacturer's model numbers are, e.g., 09-20010, 09-20015, 09-20025 and 09-20035. Different eddy current generators or cold air devices have different capacities and the cooled air produced is guided through line 80 to nozzle 81 so that the cold air flow 82 can be directed, e.g., at the printing rollers, thereby cooling them. A temperature control for printing mechanism 23 can be realized via a control of the amount of air or a control of the temperature of the air. The cooling can take place continuously or periodically. Furthermore, it is possible to provide a further temperature sensor by which the process can be controlled. Cold air flow 82 can be guided, e.g., directly at temperature-critical components such as distributor cylinder 67 and distributor roller 68.

A variation of the invention is also possible in which both a cooling plate 74 and a cold air device 79-81 are provided.

The invention is based on the idea that printing mechanism 23 is tempered so that changes in the viscosity of the printing ink and an uneven printing intensity are avoided. If the temperature falls below a predetermined desired temperatures printing mechanism 23 is heated with a heating device, e.g., a heating cartridge, and if the desired temperature is exceeded during operation, the printing mechanism is cooled by a plate through which a coolant flows. A constant printing quality is ensured through the tempering device according to the invention.

The printing mechanism components and the printing ink are kept at a predetermined operating temperature, for example 40° C., so that the high printing quality is hereby continuously ensured.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

List of Reference Numbers

1 Sluice

2 Pre-distributor

3 Removal roll

4 Storage container

5 Belt conveyor

6 Upright duct

7 Pin roll

8 Shake out roll

9 Dispersion cloth

11 Sifting device

12 Pin roll

13 Wall

14 Funnel

17 Tobacco channel

17 Rod conveyor

18 Vacuum chamber

19 Leveler

21 Cigarette paper strip

22 Bobbin

23 Printing mechanism

24 Garniture belt

26 Garniture

27 Tandem seam sealer

28 Cigarette rod

29 Rod density gauge

31 Knife device

32 Double-length cigarettes

33 Arms

34 Transfer device

36 Takeover drum

37 Filter tipping machine

38 Cutting drum

39 Conveyor belts

41 Conveyor belts

42 Container

61 Ink container

62 Ink pump

63 Connection block

64 Ink nozzle

65 Distributor cylinder

66 Distributor roller

67 Distributor cylinder

68 Distributor roller

69 Stamp roller

70 Brush

71 Pressure roller

72 Heating element

73 Temperature sensor

74 Cooling plate

75 Line

76 Cooling device

77 Temperature adjusting device

78 Cooling fluid

79 Cold air generator

80 Line

81 Nozzle

82 Cold air flow

What is claimed:

1. A printing mechanism of a machine of the tobacco processing industry comprising a tempering device.

2. The printing mechanism in accordance with claim 1, wherein the machine is a cigarette rod machine.

3. The printing mechanism in accordance with claim 1, wherein said tempering device comprises at least one of at least one heating device and or at least one cooling device.

4. The printing mechanism in accordance with claim 3, further comprising an ink supply, a metering device, and an ink nozzle, and said heating element being located with at least one of said ink supply, metering device, and ink nozzle.

5. The printing mechanism in accordance with claim 3, wherein said heating element comprises at least one of a heating cartridge and a heat sensor.

6. The printing mechanism in accordance with claim 3, further comprising an ink supply, a metering device, an ink nozzle, and a temperature sensor,
wherein said temperature sensor is positioned one of:
(a) near at least one of said ink supply, metering device, and ink nozzle; or
(b) on or in at least one of said ink supply, metering device, and ink nozzle.

7. The printing mechanism in accordance with claim 3, wherein said cooling element comprises a cooling plate.

8. The printing mechanism, in accordance with claim 7, wherein said cooling element is structured and arranged for a medium to flow through the cooling element.

9. The printing mechanism in accordance with claim 7, further comprising an ink supply, a metering device, and an ink nozzle,
wherein said ink supply, metering device, and ink nozzle are at least partially located on the cooling plate.

10. The printing mechanism in accordance with claim 7, wherein said cooling element comprises a device structured to produce a cooled air flow.

11. The printing mechanism in accordance with claim 7, wherein said cooling element comprises an eddy current generator.

12. The printing mechanism in accordance with claim 1, wherein said tempering device comprises a control or regulating unit.

13. The printing mechanism in accordance with claim 1, further comprising an ink nozzle.

14. The printing mechanism in accordance with claim 13, further comprising a heating cartridge located one of integrally in said ink nozzle or to lie against said ink nozzle.

15. The printing mechanism in accordance with claim 13, further comprising a temperature sensor located one of in and one said ink nozzle.

16. The printing mechanism in accordance with claim 13, further comprising a plurality of distributor rollers, a stamp roller, and a pressure roller,
wherein two of said plurality of distributor rollers are arranged to receive ink from said ink nozzle, and said stamp roller and said pressure roller are arranged to guide a paper strip to be printed.

17. The printing mechanism in accordance with claim 13, further comprising a device to measure ink pressure before discharge from said ink nozzle.

18. A process for printing with a printing mechanism that includes a tempering device, said process comprising:
adjusting a temperature of ink in the printing mechanism via the tempering device.

19. The process in accordance with claim 18, wherein the printing mechanism is located within a machine of the tobacco processing industry.

20. The process in accordance with claim 19, wherein said machine is a cigarette rod machine.

21. The process in accordance with claim 18, wherein the tempering device includes at least one of at least one heating element and at least one cooling element, and
wherein the ink temperature is adjusted by the at least one of the at least one heating device and the at least one cooling device.

22. The process in accordance with claim 21, wherein the ink temperature is adjusted in at least one of an ink supply, a metering device, and an ink nozzle of the printing mechanism by the at least one heating element.

23. The process in accordance with claim 22, wherein the at least one heating element comprises a heating cartridge.

24. The process in accordance with claim 21, wherein the at least one cooling element comprises a cooling plate, and
wherein the ink temperature is adjusted by the cooling plate.

25. The process in accordance with claim 24, further comprising flowing a medium through the cooling element.

26. The process in accordance with claim 21, wherein at least some components of the printing mechanism are located at least partially on the cooling plate, whereby the components are cooled by the cooling plate.

27. The process in accordance with claim 21, wherein the at least one cooling element comprises a device producing a cooled air flow, and
the ink temperature is adjusted by directing the cooled air flow toward a portion of the printing mechanism.

28. The process in accordance with claim, 18, further comprising controlling or regulating the tempering device through a control or regulation device.

29. The process in accordance with claim 18, further comprising heating the ink in the ink nozzle.

30. The process in accordance with claim 18, further comprising detecting a temperature of the ink in the ink nozzle.

31. The process in accordance with claim 18, further comprising measuring ink pressure before discharge from the ink nozzle.

32. A machine of the tobacco processing industry comprising the printing mechanism in accordance with claim 1.

33. The machine in accordance with claim 32, wherein said machine is a cigarette rod machine.

34. A process for printing a cigarette paper strip in the machine in accordance with claim 32, said process comprising:
guiding the cigarette paper strip to a printing mechanism having a tempering device; and
adjusting at least one of a temperature and a viscosity of the ink in the printing mechanism via the tempering device.
